(19) United States
(12) Patent Application Publication
(10) Pub. No.: US 2016/0123225 A1
(43) Pub. Date: May 5, 2016

(54) THERMAL INSULATION OF AN INTERNAL COMBUSTION ENGINE

(71) Applicant: BASF SE, Ludwigshafen (DE)

(72) Inventors: Han Sung PAIK, Bremen (DE); Udo HADICK, Muenster (DE); Thomas BARTZ, Stemshorn (DE); Georg PARTUSCH, Puergen (DE)

(73) Assignee: BASF SE, Ludwigshafen (DE)

(21) Appl. No.: 14/896,099

(22) PCT Filed: May 23, 2014
(86) PCT No.: PCT/EP14/60672

§ 371 Date: Dec. 4, 2015

(30) Foreign Application Priority Data
Jun. 4, 2013 (EP) 13170443.9

(51) Int. Cl. F02B 77/11; C08J 9/14; C08J 9/12; C08G 18/08

(52) U.S. Cl. CPC F02B 77/11; C08G 18/14; C08J 9/141; C08J 9/142; C08J 9/144; C08J 9/122; C08J 2203/06; C08J 2203/12; C08J 2203/142; C08J 2203/14; C08J 2375/04; C08G 2101/0083

(57) ABSTRACT

The present invention relates to a thermally insulated internal combustion engine where a polyurethane foam entirely or to some extent surrounds the external surface of one or more parts of the internal combustion engine. The present invention further relates to a process for the production of a thermally insulated internal combustion engine by taking an engine part, using a mold to surround the part that is to be surrounded with foam within the internal combustion engine part, thus producing a cavity between engine part and mold, charging a polyurethane reaction mixture into the cavity, allowing the polyurethane reaction mixture to complete its reaction to give a polyurethane foam, and removing the mold.

The present invention relates to a thermally insulated internal combustion engine where a polyurethane foam entirely or to some extent surrounds the external surface of one or more parts of the internal combustion engine. The present invention further relates to a process for the production of a thermally insulated internal combustion engine by taking an engine part, using a mold to surround the part that is to be surrounded with foam within the internal combustion engine part, thus producing a cavity between engine part and mold, charging a polyurethane reaction mixture into the cavity, allowing the polyurethane reaction mixture to complete its reaction to give a polyurethane foam, and removing the mold.

Internal combustion engines, in particular in motor vehicles, are designed with a view to particular operating temperatures which are above the ambient temperature. Operation of the cold engine leads to increased engine wear; a cold engine moreover uses markedly more fuel than at operating temperature, and emission of hazardous substances is higher, and performance of a cold engine in heating the motor vehicle is also inadequate. These problems become particularly noticeable during frequent repeated traveling of short distances. The engine cools between these journeys, and the distance traveled is frequently not sufficient to bring the engine to operating temperature. These situations lead to high levels of engine wear and unacceptable fuel consumption. The overall position is that it is advantageous that once an internal combustion engine is started it rapidly reaches operating temperature, and when briefly shut down retains the heat generated for the longest possible time so that the subsequent phase of running below operating temperature is as short as possible.

This can be achieved by way of example via the thermal insulation of the internal combustion engine. Thermal insulation of this type is known and is described by way of example in DE 199 35 335. DE 199 35 335 discloses thermal insulation made of polyurethane for internal combustion engines. The insulation here can be applied via direct foaming of the rigid polyurethane foam onto the engine casing. This can be achieved by surrounding the engine casing and the add-on assemblies with foam. The advantage of this embodiment is complete sealing of the engine casing, resulting in very good thermal insulation and in particular very good acoustic insulation. This process is moreover very easy to carry out, because all that is necessary is to apply the liquid foam components to the external surface of the engine, with no need for separate shaping and fitting of the encapsulation. However, it is disadvantageous that work on the engine requires removal of the encapsulation, this always being attended by destruction thereof. The accessibility of the external surface of the engine for maintenance work is moreover impaired, and replacement of defective components such as sensors is not easy.

Another possibility for adhesive encapsulation of engines can consist in producing the insulation in one piece or in a plurality of parts, preferably as moldings, and then adhesive-bonding these to the engine casing. Here again it is possible to achieve complete sealing of the engine casing, with the abovementioned advantages. Here again, the complete encapsulation greatly increases the difficulty of carrying out maintenance on the drive assembly. Insulation components that are subsequently adhesive-bonded to the external surface of the engine moreover require comparatively large amounts of production resource, and this results in increased costs.

Another possibility disclosed in DE 199 35 335 is encapsulation as self-supporting unit. Moldings made of polyurethane foam can be produced here, and these can be attached around the engine. Here again, it is in turn possible to design the encapsulation as one part or in the form of a plurality of parts. The advantage of this embodiment over direct foaming around the drive assembly is that it is easy to disassemble the encapsulation in the event of maintenance or repair work on the engine, and that it is possible to reuse the encapsulation. Disadvantages in comparison with direct foaming of the engine are that more resource is required for the production and attachment of the encapsulation, and also that the insulation takes up significantly more space. During operation of the engine it is moreover possible that the encapsulation becomes loosened, and that resultant leakage problems may impair the thermal and acoustic insulation of the engine.

It was therefore an object of the present invention to provide thermal insulation for an internal combustion engine which is easy to maintain, where the insulation requires only little installation space.

The object of the invention is achieved via a thermally insulated internal combustion engine, where a polyurethane foam entirely or to some extent surrounds the external surface of one or more parts of the internal combustion engine, where other parts of the internal combustion engine are entirely or to some extent not surrounded by the polyurethane foam. The object of the invention is further achieved via a process for the production of a thermally insulated internal combustion engine by taking an engine part, using a mold to surround the part that is to be surrounded with foam within the internal combustion engine part, thus producing a cavity between engine part and mold, charging a polyurethane reaction mixture into the cavity, allowing the polyurethane reaction mixture to complete its reaction to give a polyurethane foam, and removing the mold.

A conventional internal combustion engine as used by way of example in motor vehicles comprises the crankcase with the cylinder bores and the crankshaft, and also the cylinder head, which forms the upper end of the combustion chamber of an internal combustion engine. In the case of all modern four-stroke engines the cylinder head accommodates the inlet and outlet ducts and the valve control system for the gas-exchange processes, inclusive of the valves, oil ducts for the lubrication of the valve mechanism, and also in the case of water-cooled engines coolant ducts, and in the case of the spark-ignition engines the spark plugs, and in the case of diesel engines the injection nozzles. The oil sump adjoins the underside of the crankcase. The timing case is mostly attached at the frontal side of the engine and comprises by way of example, if present, the drive for the valve mechanism and the cooling-water pump. The timing case cover here seals the timing case with respect to the crankcase. Engines with high-pressure injection have an injection pump, and moreover all engines have numerous assemblies connected by screw threads to the crankcase, for example the generator, the starter, and by way of example the compressor of the air-conditioning system. An internal combustion engine can moreover for the purposes of the invention comprise a transmission system and a suction module for suction intake of the operating gas. For the purposes of the present invention these components are termed “parts of the internal combustion engine”.

It is preferable that the polyurethane foam in each case entirely or to some extent surrounds the external surface of the crankcase, of the oil sump, of the cylinder head, of the transmission casing, and/or of the timing-case cover. It is also possible to coat individual connecting components entirely or to some extent with polyurethane foam, examples being engine supports and assemblies. It is preferable here that the polyurethane foam surrounds the engine parts in a manner that results in frictional connection and/or interlock connection, and it is particularly preferable that the polyurethane foams adhere on the external surface of the relevant engine parts, for example by virtue of the adhesive effect of the polyurethane. In another preferred embodiment the polyurethane foam can also be at a distance from the external surface of the engine parts, for example from 0.1 to 10 mm. It is also preferable that there are spaces in the polyurethane foam at locations at which sensors, such as detonation sensors, are mounted on the engine.

The side facing away from the engine (external side) of the pulley, of the generator, of the water pump, and of the oil filter is to some extent not enclosed by the polyurethane foam, and is thus accessible, by way of example for maintenance work and repair work. The design of the polyurethane insulation here in the vicinity of said components is such that said components can be uninstalled without damage to the polyurethane foam. Heat loss via parts not included into the insulating polyurethane layer is preferably avoided in that an insulation layer, for example made of high-performance plastic, is placed between the part not included and the engine or the transmission, or in that the contact area is minimized.

Likewise at least to some extent not enclosed by the polyurethane foam are external surfaces of engine parts which can have an operating temperature above 180° C., for example the manifold flange of the exhaust system, the catalyst, or any turbocharger present. The intention is as far as possible to avoid overheating of these components during operation. In order to prevent possible destruction of polyurethane foam in the environment of these high-temperature components, it is preferable that these high-temperature components are insulated from the polyurethane foam with high-temperature-resistant insulation materials, for example glassfiber mats and/or mineral insulation materials, for example mineral-fiber nonwovens. It is preferable that in the vicinity of the high-temperature components between polyurethane layer and high-temperature component, either alongside or instead of the high-temperature-resistant insulation materials, a further coating is applied which is made of high-temperature-resistant stimulation materials capable of protecting the polyurethane foam from radiated heat. It is particularly preferable that this is a foil having a metallic surface, for example an aluminum foil. This radiation protection can also have been applied on the surface of the polyurethane. It is particularly preferable that the external surface of the high-temperature components not facing any polyurethane insulation has no thermal insulation, so that heat can be dissipated and said parts do not overheat.

The design of the insulating polyurethane layer is usually such as to maximize reduction of heat dissipation from the engine, but also to avoid any excessive requirement for installation space. The thickness of the insulating polyurethane layer is therefore usually from 1 to 100 mm, preferably from 5 to 50 mm, and particularly preferably from 10 to 40 mm. In the case of direct adhesion of the polyurethane foam on the motor parts here there is no need for any separate, subsequent adhesive bonding, or for any seal between the insulated engine parts.

In order to provide protection from aggressive liquids, such as fuel, engine oil, brake fluid, or antifreeze, there can also be a metal layer, for example a thin aluminum layer, surrounding the internal side and/or the external side of the polyurethane foam. This moreover also leads to additional reflection of radiated heat. It is moreover also possible to provide a decorative design to the exterior surface.

It is preferable that the polyurethane foams used in the invention are highly resistant to temperature change. They must withstand prolonged exposure to a temperature of at least 140° C., preferably 150° C., and particularly preferably 180° C., preferably over a period of from 10 to 20 years, without impairment.

The polyurethane foams can also comprise at least one layer which serves for insulation with respect to solid-borne sound. Examples here are polyurethanes with specific fillers, for example barite. As far as possible the layers are middle layers or are on the side facing away from the engine, because they are mostly not resistant to temperature change. It is preferable here that the thickness of the layer providing insulation from solid-borne sound is from 0.5 to 10 mm.

The polyurethane foams used in the invention are produced via reaction of polyisocyanates with compounds having at least two hydrogen atoms reactive toward isocynate groups. The rigid polyurethane foams that are preferably used, these being foams resistant to temperature change, are preferably produced by using the following starting components:

Polyisocyanates used are usually aliphatic and/or aromatic polyisocyanates, preferably aromatic polyisocyanates. The most important industrial materials here are tolylene diisocyanate isomers, and in particular diphenylmethane diisocyanate isomers. However, it is preferable to use mixtures of diphenylmethane diisocyanates and polyphenylene polymethylene polyisocyanates, known as crude MDI. Other polyisocyanates that can be used are those known as modified polyisocyanates, i.e. polyisocyanates modified via incorporation of, for example, urethane groups, allophanate groups, or isocyanurate groups. Materials particularly important for use in rigid polyurethane foams resistant to temperature change are polyisocyanates modified with isocyanurate groups; the rigid foams produced from these are often also termed polyisocyanurate foams (PIR foams).

Compounds used having at least two hydrogen atoms reactive toward isocyanate groups are mostly polyether alcohols and/or polyester alcohols with molecular weights of more than 400 to about 20 000 daltons.

The polyester alcohols are reaction products of polybasic carboxylic acids with polyhydric alcohols. Materials used in practice are mostly dibasic carboxylic acids and dihydric alcohols, to which small quantities of higher-functionality alcohols, mostly trihydric alcohols, can be added. Production of the polyurethane foams used in the invention preferably uses polyester alcohols which comprise aromatic structures. It is preferable to use polyester alcohols in the production of polyisocyanurate foams.

Production of the polyurethanes used in the invention preferably uses polyether alcohols. The polyether alcohols are mostly produced via catalytic formation of adducts of alkylene oxides, in particular ethylene oxide and/or propylene oxide, with H-functional starter substances. Starter substances used are mostly polyhydric alcohols, for example glycols, glycerol, trimethylolpropane, pentaerythritol, or sugar alcohols, for example mannitol, sorbitol, sucrose, polyfunctional aliphatic and/or aromatic amines, and/or aminoalcohols, for example ethylenediamine, ethanolamine, tolylenediamine, diphenylmethanediamine, or a mixture of diphenylmethanediamine and polymethylene polyphenylene polyamine, or H-functional Mannich condensates.

Among the compounds having at least two hydrogen atoms reactive toward isocyanate groups are also those known as chain extenders and/or crosslinking agents. These are alcohols and/or amines with molecular weights of from 62 to 400 daltons. Chain extenders here have two hydrogen atoms reactive toward isocyanate, and crosslinking agents have at least three hydrogen atoms reactive toward isocyanate.

For the production of the polyurethanes used in the invention, at least a portion of the compounds having at least two hydrogen atoms reactive toward isocyanate groups comprises aromatic structures. Rigid polyurethane foams that have proven particularly successful are those in which from 10 to 20% by weight of the compounds having at least two hydrogen atoms reactive toward isocyanate groups consists a polyether alcohol based on aromatic amines, in particular tolylenediamine.

The rigid polyurethane foams are mostly produced with use of conventional urethane-forming catalysts, for example tertiary amines, or organic and/or inorganic heavy metal salts. Blowing agents used are water and/or known physical blowing agents, for example alkanes, cycloalkanes, halogenated alkanes, ketones, or other substances that vaporize during the urethane-forming reaction. It is also possible to add gases, for example carbon dioxide, to the liquid urethane-forming components.

The envelope density of the polyurethane foams used in the invention is preferably from 40 to 200 g/l, in particular from 60 to 120 g/l. Thermal conductivity is preferably in the range from 0.010 to 0.050 W/m*K. They are resistant to temperature change up to a long-term service temperature of 140° C., in particular 150° C., and preferably 180° C.

It is preferable that the production of the thermally insulated internal combustion engine comprises taking one or more engine parts, using a mold to surround the part that is to be surrounded with foam, thus producing a cavity between engine part and mold, charging a polyurethane reaction mixture into the cavity, allowing the polyurethane reaction mixture to complete its reaction to give a polyurethane foam, and removing the mold. To this end it is preferable that the starting components for the production of the polyurethane foams of the invention are mixed at a temperature of from 15 to 90° C., particularly from 25 to 55° C., and that the reaction mixture is introduced optionally under increased pressure into the mold. The mixing can be carried out mechanically by means of a stirrer or a mixing screw, or under high pressure in what is known as the countercurrent injection process. The mold temperature is advantageously from 20 to 160° C., preferably from 30 to 120° C., particularly preferably from 30 to 60° C. For the purposes of the invention the term reaction mixture is used for the mixture of the starting components when conversions in the reaction are smaller than 90%, based on the isocyanate groups.

It is possible here that engine parts are insulated individually and subsequently installed, or that entire modules of the internal combustion engine are simultaneously surrounded with foam. It is preferable that the polyurethane foam is compacted in the mold. The compaction ratio here is preferably from 1.1 to 10, particularly preferably from 1.5 to 7, and in particular from 2 to 5. The compaction ratio here derives from the ratio of free-foamed density to molding density.

The use of a mold to form the cavity here has the following advantages: the mold allows dimensioning of the precise thickness of the material in each area in accordance with requirements. The frictional connection and/or interlock connection or, respectively, adhesive connection to the external surface of the component is achieved directly via the adhesive effect of the polyurethane reaction mixture and the shaping procedure. This gives a gastight connection between polyurethane and engine parts surrounded with foam, thus reliably avoiding possible leakage problems that occur with a self-supporting insulation unit. The design of the mold here is preferably such that all of the external surface regions which are not intended to be covered with polyurethane foam are kept uncovered during the foaming process. It is thus possible to achieve all of the connections required at the external surface of the engine. In particular, space is kept free from the polyurethane foam for connections for sensors, fuel lines, oil lines, electrical conductors, assemblies, holders, and the screw-thread connections. Unlike in the case of a freely applied insulation layer made of polyurethane foam, therefore, accessibility of said connections is ensured, and disassembly/reassembly is thus possible. Another advantage of the process of the invention for foaming around engine parts with the use of a mold is that the polyurethane reaction mixture in the mold forms a mold skin featuring increased surface robustness. This improves the general functionality of the foam surface by making it more resistant and less easily damaged by contamination. Application of the foam insulation in a mold cavity moreover also provides the possibility that add-on parts of the internal combustion engine, for example liquid lines, cables and plug casings, or fastening elements, can be concomitantly included in the insulation component, i.e. concomitantly enclosed by the polyurethane foam. Inclusion in the foam insulation here permits omission of dedicated holders or attachment points on the surface of the drive system. Production costs can thus be saved, and assembly can thus be rendered easier. Advantageous design in respect of the integration of add-on parts into the insulation component can moreover have an advantageous effect on noise emission from the add-on parts, and reduce the stress to which the add-on parts are exposed through acceleration forces. Use of a mold also permits simultaneous application to the polyurethane foam, in one operation, of a coating which can by way of example consist of a metal foil or plastics foil. To this end, by way of example a plastics foil or metal foil is placed as surface coating into the mold before the polyurethane reaction mixture is introduced. This has an advantageous effect on robustness, radiation properties, chemicals resistance, and/or the perceived quality of the surface.

A thermally insulated internal combustion engine of the present invention is usually obtained via assembly after production of the insulated engine parts.

Advantages of the present invention are reduced consumption due to shorter periods of running at low operating temperature, reduced emission of hazardous substances, improved heating performance, in particular in the case of reduced-consumption drive systems, and reduced noise emission.

1. A thermally insulated internal combustion engine comprising a polyurethane foam entirely or to some extent surrounding an external surface of one or more parts of the internal combustion engine.

2. The thermally insulated internal combustion engine according to claim 1, wherein the polyurethane foam surrounds the external surface of one or more parts of the internal combustion engine in a manner that results in interlock connection and/or frictional connection.

3. The thermally insulated internal combustion engine according to claim 2, wherein the polyurethane foam adheres on the external surface of the one or more parts of the internal combustion engine.

4. The thermally insulated internal combustion engine according to claim 1, wherein the polyurethane foam is at a distance of from 0.1 to 10 mm from the external surface of the one or more parts of the internal combustion engine.

5. The thermally insulated internal combustion engine according to claim 1, wherein the polyurethane foam has apertures configured for sensors, fuel lines, oil lines, electrical conductors, and/or for assemblies and/or holders, and/or for the screw-thread connections.

6. The thermally insulated internal combustion engine according to claim 1, wherein the polyurethane foam entirely or to some extent surrounds the external side of an oil sump.

7. The thermally insulated internal combustion engine according to claim 1, wherein the polyurethane foam entirely or to some extent surrounds the external side of a crank case.

8. The thermally insulated internal combustion engine according to claim 1, wherein the polyurethane foam entirely or to some extent surrounds the external side of a cylinder head.

9. The thermally insulated internal combustion engine according to claim 1, wherein the polyurethane foam entirely or to some extent surrounds the external side of a timing-case cover.

10. The thermally insulated internal combustion engine according to claim 1, wherein the polyurethane foam entirely or to some extent surrounds the external side of a transmission casing.

11. The thermally insulated internal combustion engine according to claim 1, wherein at least to some extent the polyurethane foam does not surround the external side of pulleys, or of add-on assemblies.

12. The thermally insulated internal combustion engine according to claim 1, wherein engine parts which can have an operating temperature above 180° C. are insulated from the polyurethane foam.

13. The thermally insulated internal combustion engine according to claim 1, wherein the polyurethane foam encloses add-on parts.

14. A process for the production of the thermally insulated internal combustion engine according to claim 1, which comprises taking an engine part, using a mold to surround the part that is to be surrounded with foam within the internal combustion engine part, thus producing a cavity between engine part and mold, charging a polyurethane reaction mixture into the cavity, allowing the polyurethane reaction mixture to complete its reaction to give a polyurethane foam, and removing the mold.

15. The process according to claim 14, wherein a metal foil or plastics foil is inserted into the mold before the polyurethane reaction mixture is added.

16. The process according to claim 15, wherein the polyurethane foam is compacted in the mold, and the compaction factor is from 1.1 to 10.

17. The process according to claim 15, wherein the mold is configured such that connections on the engine for sensors, fuel lines, oil lines, electrical connection lines, assemblies, holders, and the screw-thread connections are kept free from the polyurethane foam.
